(19) United States
(12) Patent Application Publication
(10) Pub. No.: US 2005/0287290 A1
(43) Pub. Date: Dec. 29, 2005

(54) Gas diffusion electrodes and membrane electrode assemblies for proton exchange membrane fuel cells

(75) Inventors: Riqing Zhang, Shenzhen (CN); Junqing Dong, Shenzhen (CN)

Correspondence Address: EMIL CHANG;LAW OFFICES OF EMIL CHANG, 874 JASMINE DRIVE, SUNNYDALE, CA, 94086, US

(73) Assignee: BYD Company Limited

(21) Appl. No.: 11/157,609

(22) Filed: Jun. 20, 2005

(30) Foreign Application Priority Data
Jun. 23, 2004 (CN) 200410027867.2

(51) Int. Cl. B05D 5/12

(52) U.S. Cl. 427/115

(57) ABSTRACT

This invention discloses fabrication methods for membrane electrode assemblies of proton exchange membrane fuel cells, including gas diffusion electrodes. The fabrication methods of gas diffusion electrodes include the following steps: fabricating a conductive substrate; forming a layer of carbon containing material onto said conductive substrate; subjecting said conductive substrate with said carbon containing material to pressure at a predetermined temperature; cooling said conductive substrate with said material having carbon under pressure to obtain a gas diffusion layer on said conductive substrate; coating a layer of catalyst containing material onto said gas diffusion layer; subjecting said layer of catalyst containing material with gas diffusion layer and conductive substrate to pressure at another predetermined temperature; cooling under pressure to form a gas diffusion electrode. Compared with the existing technologies, all layers within the membrane electrode assemblies are bonded together tightly and will not separate easily. In addition, during fabrication, the gas diffusion electrodes are not easily distorted. These fabrication methods are simple, easy to implement, have good reproducibility and produces electron membrane with excellent synthetic electrical properties.

### CROSS REFERENCE

This application claims priority from a Chinese patent application entitled “Methods for Fabricating Membrane Electrode Assemblies for Proton Exchange Membrane Fuel Cells” filed on “Jun. 23, 2004,” having a Chinese Application No. 200410027867.2. This Chinese application is incorporated herein by reference.

### FIELD OF INVENTION

This invention relates to the fabrication methods of electrodes for fuel cells. Particularly, it relates to the fabrication methods for membrane electrode assemblies of proton exchange membrane fuel cells and their components, including gas diffusion electrodes.

### BACKGROUND

Proton exchange membrane fuel cells are devices that produce electric energy from electrochemical reactions between the hydrogen ion producing fuel and oxygenic gases such as oxygen or air. These fuel cells are one of the electrical sources for the future because their noise level is low; they have high energy-conversion efficiency, and, they do not cause environmental pollution. They can be used as the power source in small portable electrical power supplies, small home power generators, and electric automobiles.

The core of a proton exchange membrane fuel cell is the membrane electrode assembly. This is where the electrochemical reaction occurs and where simultaneous conduction functions for protons and electrons are needed. Its structure and properties significantly affect the synthetic electrical properties of the proton exchange membrane fuel cells.

Currently, there are several different methods for fabricating these membrane electrode assemblies. The quantity of the catalyst used by these methods is also gradually decreasing. The customary method for fabricating a membrane electrode assembly is: mixing catalyst, a predetermined quantity of solvent, binding agent and proton exchange resins; dispersing uniformly with ultrasound; coating the catalyst paste uniformly on conductive carbon paper or carbon cloth; drying with heat; spray coating a layer of proton exchange resin solution on the surface of the catalyst layer to form an interface between the electrode and proton exchange membrane, hot pressing at a pre-determined temperature and pressure the negative electrode, positive electrode and proton exchange membrane together to form a unit. Although this fabrication method for membrane electrodes is easy, the surfaces of the diffusion and catalyst layers on the carbon paper cannot always be made uniformly smooth. After drying, these surfaces become rough and uneven, reducing the utilization rate of the catalyst in the catalyst layer. In addition, the rough surfaces will also result in poor contact at the interface between the catalyst layer and proton exchange membrane such that defects are easily created and the properties of the membrane electrodes are affected.

Chinese patent CN1471186A, “Combination of Electrolyte Membrane Electrode Used in Fuel Cells, Using this Type of Fuel Cell and their Fabrication Methods,” disclosed a method for fabricating membrane electrodes using transfer printing. This method includes the following steps: mixing a catalyst with a macromolecular electrolyte; coating the mixture on a thin slice for the transfer printing; drying the catalyst paste by heat; joining together the thin slices with the catalyst layer and proton exchange membrane by pressing at a high temperature and a high pressure; peeling off the slice; and hot-pressing the catalyst layer with the gas diffusion layer such that the three layers are joined as one to form a complete MEA. This fabrication method enables the fabrication of electrodes with a thinner catalyst layer as the interface between the catalyst layer and membrane is continuous. However, this fabrication method is complicated as it involves multiple steps. In addition, during the transfer printing, a partial catalyst layer can easily adhere to the slice and be peeled off with the slice. Therefore, the properties of the electrode are affected as the transfer of the catalyst layer may not always be complete and the evenness of the catalyst layer may not always be even.

Due to the limitations of the prior art, it is therefore desirable to have novel methods of fabricating membrane electrode assemblies that are convenient, easy, and fast, and that produce membrane electrodes that have excellent synthetic electrical properties.

### SUMMARY OF INVENTION

An object of this invention is to provide fabrication methods for membrane electrode assemblies of proton exchange membrane fuel cells that are convenient, easy, and fast.

Another object of this invention is to provide fabrication methods for membrane electrodes with excellent synthetic electrical properties.

Briefly, this invention discloses the fabrication methods for membrane electrode assemblies of proton exchange membrane fuel cells, including gas diffusion electrodes. The fabrication methods for gas diffusion electrodes include the following steps: fabricating a conductive substrate; forming a layer of carbon containing material onto said conductive substrate; subjecting said conductive substrate with said carbon containing material to pressure at a predetermined temperature; cooling said conductive substrate with said material having carbon under pressure to obtain a gas diffusion layer on said conductive substrate; coating a layer of catalyst containing material onto said gas diffusion layer; subjecting said layer of catalyst containing material with gas diffusion layer and conductive substrate to pressure at another predetermined temperature; cooling under pressure to form a gas diffusion electrode. The fabrication of the membrane electrode assemblies include the following steps: placing and aligning two gas diffusion electrodes on the two sides of a membrane, subjecting these two gas diffusion electrodes with the membrane under pressure at a predetermined temperature, and then cooling said diffusion electrodes with said membrane under pressure to form a membrane electrode assembly.

An advantage of this invention is that the fabrication methods of the present invention are convenient, easy, and fast.

Another advantage of the present invention is that the membrane electrodes fabricated using the methods of this invention have excellent synthetic electrical properties.

### DETAILED DESCRIPTION OF THE PREFERRED EMBODIMENTS

### Fabrication of Embodiments of Gas Diffusion Electrodes

The presently preferred methods of the present invention for the fabrication of the gas diffusion electrodes include the following steps:

fabricating a conductive substrate;

forming a layer of first material having carbon onto said conductive substrate;

first hot-pressing, i.e., subjecting said conductive substrate with said layer of first material having carbon to a predetermined pressure (first hot-pressing pressure) at a predetermined temperature (first hot-pressing temperature);

first cooling under pressure (first cooling pressure) to obtain a gas diffusion layer on said conductive substrate;

coating a layer of catalyst material onto said gas diffusion layer;

second hot-pressing, i.e., subjecting said conductive substrate with said gas diffusion layer and said layer of catalyst material to a predetermined pressure (second hot-pressing pressure) at a predetermined temperature (second not-pressing temperature); and

second cooling under pressure (second cooling pressure) to form a gas diffusion electrode.

In the preferred methods, one or more of the following conditions can be selected:

The first hot pressing of said conductive substrate with said layer of first material having carbon is conducted at a first hot-pressing temperature between 20° C. and 120° C. and with a first hot-pressing pressure between 0.05 and 5 Mpa for 30 seconds to 300 seconds;

The first cooling is conducted either naturally or with water;

The first cooling pressure is between 0.05 Mpa and 5 Mpa.

The thickness of the gas diffusion layer after hot pressing is between 100 and 600 micrometers;

The thickness of the gas diffusion layer after said first hot-pressing is 1% to 20% less than the thickness of the layer of first material having carbon before said first hot-pressing. That is, the thickness of the gas diffusion layer after said first hot-pressing is 80% to 99% of the thickness of the layer of first material having carbon before said first hot-pressing;

Said catalyst material comprises of a solvent that is a mixture of isopropyl alcohol and water;

Said catalyst material comprises of a pore forming agent. The pore forming agent can be ammonium bicarbonate, ammonium formate, ammonium acetate or ammonium oxalate;

Said catalyst material is a mixture comprising of: Pt/C catalyst, solvent, pore forming agent and Nafion solution;

In said catalyst material, the ratio of: Pt/C catalyst, solvent, pore forming agent and Nafion solution is 1-30:10-100:3-30:1-10;

The content of Pt in the Pt/C catalyst is between 20 and 40%;

Said catalyst material is coated onto the gas diffusion layer by spray coating or brush coating;

The second hot-pressing is conducted at a second hot-pressing temperature of between 20° C. and 120° C. and a second hot-pressing pressure of between 0.05 Mpa and 5 Mpa for 10 seconds to 300 seconds;

The second cooling is conducted either naturally or with water;

The second cooling pressure is between 0.05 Mpa and 5 Mpa.

The thickness of the gas diffusion electrode after hot pressing is between 150 and 800 microns; and

The thickness of said gas diffusion electrode after said second hot-pressing is 1 to 20% less than the thickness of said conductive substrate with said layer of catalyst material and gas diffusion layer before said second hot-pressing. That is, the thickness of said gas diffusion electrode after second hot-pressing is 80% to 99% of the thickness said conductive substrate with said layer of catalyst material and gas diffusion layer before said second hot-pressing.

Fabrication of Membrane Electrode Assemblies

The presently preferred methods for the fabrication of the membrane electrode assemblies include the following steps:

placing and aligning a membrane between two gas diffusion electrodes;

third hot-pressing, i.e., subjecting said membrane with two gas diffusion electrodes to a predetermined pressure (third hot-pressing pressure) at a predetermined temperature (third hot-pressing temperature); and

third cooling under pressure (third cooling pressure) to form said membrane electrode assembly.

In the preferred methods, one or more of the following conditions can be selected:

The membranes used are Nafion membranes, preferably, Nafion 112 membrane or Nafion 115 membrane or other Nafion membranes in the same series;

The third hot-pressing is conducted at a third hot-pressing temperature of between 100° C. and 140° C. and a third hot-pressing pressure of between 3 Mpa and 10 Mpa for 30 seconds to 300 seconds;

The third cooling is conducted either naturally or with water; and

The thickness of the membrane electrode assembly is between 350 microns and 1700 microns.

Fabrication of Conducting Substrates

The presently preferred methods for fabricating the conducting substrates include the following steps:

maintaining a material having carbon (second material having carbon) at a predetermined temperature (first maintenance temperature);

maintaining said second material having carbon at a predetermined temperature (second maintenance temperature); and

cooling to obtain said conductive substrate.

The presently preferred methods for fabricating said second material having carbon include the following steps:

soaking a material having carbon (fourth material having carbon) in a first PTFE material such as a first PTFE material.

removing said soaked fourth material having carbon from said first PTFE material; and

drying said soaked fourth material having carbon to form said second material having carbon.

In the preferred methods, one or more of the following conditions can be selected:

Said fourth material having carbon can be either carbon paper or carbon cloth;

The concentration of PTFE in said first PTFE material is between 2% and 35%;

Said soaked fourth material having carbon is dried with heat at a temperature between 20° C. and 80° C.;

The second maintenance temperature is higher than said first maintenance temperature;

Said first maintenance temperature is between 240° C. and 290° C.;

Said second maintenance temperature is between 300° C. and 360° C.;

The first maintenance temperature is maintained for between 15 minutes and 30 minutes; and

The second maintenance temperature is maintained for between 15 minutes and 30 minutes.

Fabrication of Layer of First Material Having Carbon

The preferred methods for forming the first material having carbon include the following steps:

coating a third material having carbon onto said conductive substrate; drying;

maintaining said third material having carbon at a third maintenance temperature;

maintaining said third material having carbon at a fourth maintenance temperature; and

cooling to form said layer of first material having carbon.

In the preferred methods, one of or more of the following conditions is selected:

Said third material having carbon can either be a paste mixture of VXC-72 carbon black and second PTFE material such as a PTFE paste, or, a paste mixture of acetylene black and second PTFE material such as a PTFE paste;

The content of said PTFE in the second PTFE material is between 5% and 40%;

Said third material having carbon is coated onto the gas diffusion layer by spray coating or brush coating;

The drying of said second carbon having material conducted with heat at a temperature of between 20° C. and 80° C.;

The fourth maintenance temperature is higher than the third maintenance temperature;

Said third maintenance temperature is between 240° C. and 290° C.;

Said fourth maintenance temperature is between 300° C. and 360° C.;

Said third maintenance temperature is maintained for between 15 minutes and 30 minutes;

Said fourth maintenance temperature is maintained for between 15 minutes and 30 minutes; and

In said cooling step after maintaining said third and fourth temperatures, the cooling is conducted either naturally or with water to room temperature;

When compared to the current technologies, the three-step pressing methods of this invention, pressing the gas diffusion layer, the gas diffusion electrodes, and the membrane electrode results in tighter adhesion between the different layers such that the layers are not easily separated. The electrodes fabricated from cooling under pressurized condition after hot pressing will not easily distort or create defects. In addition, these methods also create excellent contact between the catalyst layer and proton exchange membrane. This improves the properties of the membrane electrodes. These fabrication methods are simple, easy, and have good reproducibility.

The following methods further describe this invention.

### Embodiment 1

The fabrication method for the membrane electrode assembly of this embodiment includes the fabrication of the conductive substrate, the gas diffusion electrode, and finally, the membrane electrode assembly. The fabrication of the conductive substrate includes the following steps:

soaking a material having carbon (fourth material having carbon) such as carbon paper or carbon cloth, in a PTFE paste;

drying with heat at a temperature between 20° C. and 80° C.;

placing soaked carbon paper or carbon cloth in a furnace;

raising the furnace temperature to between 240° C. and 290° C.;

maintaining said temperature for 15 to 30 minutes;

raising the temperature to between 300° C. and 360° C.; and

retaining the temperature for 15 to 30 minutes to obtain a conductive substrate.

The fabrication of the gas diffusion layer of the gas diffusion electrode includes the following steps:

mixing VXC-72 carbon black or acetylene black with a PTFE paste to form a paste where the content of the PTFE in the PTFE paste is between 5% and 40%;

coating the conductive substrate with said paste by spray coating or brush coating;

drying said paste with heat at a temperature between 20° C. and 80;

placing said conductive substrate with dried paste in a furnace;

raising the temperature to between 240° C. and 290° C.;

maintaining the temperature for 15 minutes to 30 minutes;

raising the temperature to between 300° C. and 360° C.;

maintaining the temperature for 15 to 30 minutes;

cooling to room temperature to form a layer of first material having carbon;

first hot-pressing the conductive substrate with carbon black (first material having carbon) at a temperature between 20° C. and 120° C. and a pressure between 0.05 MPa and 5 MPa for 30 seconds to 300 seconds;

first cooling naturally or with water while retaining a pressure between 0.05 MPa and 5 MPa to avoid distortion and obtain a gas diffusion layer with thickness between 100 and 600 microns. This thickness is between 1% and 20% less than the thickness of said layer of first material having carbon.

The fabrication of the gas diffusion electrode includes the following steps:

mixing uniformly the Pt/C catalyst, solvent, pore forming agent and Nafion solution to form a paste where the content of Pt in said Pt/C catalyst is between 20% and 40%, said solvent is a mixture of isopropyl alcohol and water; said pore forming agent are volatile chemicals such as ammonium bicarbonate, ammonium formate, ammonium acetate or ammonium oxalate; and the ratio of said catalyst:solvent:pore forming agent:Nafion solution is 1-30:10-100:3-30:1-10;

coating said catalyst paste onto the gas diffusion layer with the conductive substrate by spray coating or brush coating;

second hot-pressing at a temperature between 20° C. and 120° C. and a pressure between 0.05 MPa and 5 Mpa for 10 to 300 seconds; and

second cooling naturally or by water while maintaining a pressure of between 0.05 MPa and 5 MPa to avoid distortion and to obtain a gas diffusion electrode. The thickness of the gas diffusion electrode after said second hot-pressing is between 150 microns and 800 microns. This thickness is 1% to 20% less than the thickness of the conductive substrate with said gas diffusion layer and said layer of catalyst material before said second hot-pressing.

The fabrication of three-in-one membrane electrode assembly includes the following steps:

placing and aligning a Nafion membrane between the two gas diffusion electrodes with catalyst layers where the Nafion membrane used can be Nafion 112, Nafion 115 membrane or other membranes in that series;

third hot-pressing at a temperature between 100° C. and 140° C. and a pressure between 3 MPa and 10 MPa for 30 to 300 seconds; and

third cooling naturally or with water to room temperature at a pressure between 3 MPa and 10 MPa to avoid separation and obtain a membrane electrode assembly. The thickness of the three-in-one membrane electrode assembly after said third hot-pressing is between 350 microns and 1700 microns.

### Embodiment 2

The fabrication method of the membrane electrode assembly of this embodiment includes the fabrication of the conductive substrate, the gas diffusion electrode, and finally, the membrane electrode assembly. The fabrication of the conductive substrate includes the following steps:

soaking carbon paper in a PTFE paste where the content of the PTFE in said paste is 10%;

drying with heat at a temperature 50° C.;

placing said dried paper in a furnace;

raising the temperature of said furnace to 240° C.;

maintaining that temperature for 30 minutes;

raising the temperature to 360° C.; and

maintaining that temperature for 30 minutes to obtain a conductive substrate.

The fabrication of the gas diffusion electrode includes the following steps:

mixing VXC-72 carbon black with a PTFE paste to form a paste, where the content of the PTFE in said paste is 10%;

spray coating the conductive substrate with said paste;

drying said coated conductive substrate with heat at 40° C.;

placing said dried conductive substrate in a furnace;

raising the temperature of the furnace to 240° C.;

maintaining that temperature for 30 minutes;

raising the temperature to 360° C.;

maintaining that temperature for 30 minutes;

cooling to room temperature to form a layer of first material having carbon;

first hot-pressing the cooled conductive substrate with a layer of carbon black (first material having carbon) at 120° C. and a pressure of 1 MPa for 100;

naturally first cooling at a pressure of 1 MPa to avoid distortion and obtain a gas diffusion layer with a thickness of 200 microns;

formulating the catalyst paste by mixing uniformly with ultrasound a catalyst, a solvent, a pore forming agent, and Nafion solution, where the catalyst is Pt/C and the content of said Pt is 20%, the solvent is a mixture of isopropyl alcohol and water; the pore forming agent is ammonium bicarbonate; and the ratio of the catalyst:solvent:pore forming agent:Nafion solution is 5:100:3:3;

coating the catalyst paste onto the diffusion layer where the coating method can be spray coating;

second hot-pressing at a temperature of 80° C. and a pressure of 0.5 MPa for 60 seconds; and

naturally second cooling at a pressure of 0.5 MPa to avoid distortion and to form a gas diffusion electrode with a thickness of 220 microns.

The method for fabricating the membrane electrode assembly includes the following steps:

placing and aligning a treated Nafion 115 membrane between two gas diffusion electrodes obtained from hot pressing;

third hot-pressing at a temperature of 120° C. and a pressure of 5 MPa for 100 seconds;

removing from heat immediately; and

naturally third cooling to room temperature at a pressure of 5 MPa to avoid separation and obtain a three-in-one membrane electrode assembly with a thickness of 470 microns.

### Embodiment 3

The fabrication method of the membrane electrode assembly of this embodiment includes the fabrication of the conductive substrate, the gas diffusion electrode, and finally, the membrane electrode assembly. The fabrication of the conductive substrate includes the following steps:

soaking carbon paper in a PTFE paste where the content of the PTFE in said paste is 5%;

drying with heat at a temperature 60° C.;

placing said dried paper in a furnace;

raising the temperature of said furnace to 250° C.;

maintaining that temperature for 20 minutes;

raising the temperature to 350° C.; and

maintaining that temperature for 15 minutes to obtain a conductive substrate.

The fabrication of the gas diffusion electrode includes the following steps:

mixing acetylene black a PTFE paste to form a paste, where the content of the PTFE in said paste is 20%;

spray coating the conductive substrate with said paste;

drying said coated conductive substrate with heat at 80° C.;

placing said dried conductive substrate in a furnace;

raising the temperature of the furnace to 250° C.;

maintaining that temperature for 20 minutes;

raising the temperature to 350° C.;

maintaining that temperature for 15 minutes;

cooling to room temperature to form a layer of first material having carbon;

first hot-pressing the cooled conductive substrate with a layer of carbon black (first material having carbon) at 100° C. and a pressure of 0.5 MPa for 30 seconds;

first cooling with water at a pressure of 0.5 MPa to avoid distortion and obtain a gas diffusion layer where the thickness of the gas diffusion layer after first hot-pressing is 10% less than the thickness of the conductive substrate with said layer of first material having carbon before said first hot-pressing;

formulating the catalyst paste by mixing uniformly with ultrasound a catalyst, a solvent, a pore forming agent, and Nafion solution, where the catalyst is Pt/C and the content of said Pt is 40%, the solvent is a mixture of isopropyl alcohol and water; the pore forming agent is ammonium oxalate; and the ratio of the catalyst:solvent:pore forming agent:Nafion solution is 6:80:10:10;

coating the catalyst paste onto the gas diffusion layer where printing can be the coating method;

second hot-pressing at a temperature of 100° C. and a pressure of 1 MPa for 30 seconds; and

second cooling with water at a pressure of 1 MPa to avoid distortion and obtain a gas diffusion electrode, where the thickness of the gas diffusion electrode after said second hot-pressing is 12% less than the thickness of said conductive substrate with said gas diffusion layer and said layer of catalyst material before said second hot-pressing

The method for fabricating the membrane electrode assembly includes the following steps:

placing and aligning a treated Nafion 112 membrane between two gas diffusion electrodes obtained from a first and second hot-pressing;

third hot-pressing at a temperature of 130° C. and a pressure of 8 MPa for 200 seconds;

removing from heat immediately; and

third cooling with water room temperature at a pressure of 8 MPa to avoid separation seconds and obtain a three-in-one membrane electrode assembly with a thickness of 520 microns.

### Embodiment 4

The fabrication method of the membrane electrode assembly of this embodiment includes the fabrication of the conductive substrate, the gas diffusion electrode, and finally, the membrane electrode assembly. The fabrication of the conductive substrate includes the following steps:

soaking carbon paper in a PTFE paste where the content of the PTFE in said paste is 35%;

drying with heat at a temperature 80° C.;

placing said dried paper in a furnace;

raising the temperature of said furnace to 290° C.;

maintaining that temperature for 15 minutes;

raising the temperature to 340° C.; and

maintaining that temperature for 20 minutes to obtain a conductive substrate.

The fabrication of the gas diffusion electrode includes the following steps:

mixing acetylene black a PTFE paste to form a paste, where the content of the PTFE in said paste is 40%;

spray coating the conductive substrate with said paste;

drying said coated conductive substrate with heat at 20° C.;

placing said dried conductive substrate in a furnace;

raising the temperature of the furnace to 290° C.;

maintaining that temperature for 15 minutes;

raising the temperature to 340° C.;

maintaining that temperature for 25 minutes;

cooling to room temperature to obtain a layer of first material having carbon;

first hot-pressing the cooled conductive substrate with a layer of carbon black (first material having carbon) at 20° C. and a pressure of 5 MPa for 300 seconds;

first cooling with water at a pressure of 5 MPa to avoid distortion and obtain a gas diffusion layer, where the thickness of the gas diffusion layer after first hot-pressing is 600 microns, 20% less than the thickness of the layer of first material having carbon before said first hot-pressing;

formulating the catalyst paste by mixing uniformly with ultrasound a catalyst, a solvent, a pore forming agent, and Nafion solution, where the catalyst is Pt/C where the content of said Pt is 30%; the solvent is a mixture of isopropyl alcohol and water; the pore forming agent is ammonium formate; and the ratio of the catalyst:solvent:pore forming agent:Nafion solution is 30:10:30:9;

coating the catalyst paste on the diffusion layer where brush coating can be the coating method;

second hot-pressing at a temperature of 120° C. and a pressure of 5 MPa for 300 seconds; and

second cooling with water at a pressure of 5 MPa to avoid distortion and obtain the gas diffusion electrode, where the thickness of the gas diffusion electrode after second hot-pressing is 800 microns, 20% less than the thickness of the conductive substrate with said gas diffusion layer and said layer of catalyst material before said second hot-pressing.

The method for fabricating the membrane electrode assembly includes the following steps:

placing and aligning a treated Nafion 115 membrane between two gas diffusion electrodes obtained from first and second hot-pressing;

third hot-pressing at a temperature of 140° C. and a pressure of 10 MPa for 300 seconds;

removing from heat immediately; and

cooling with water to room temperature at a pressure of 10 MPa to avoid separation and obtain three-in-one membrane electrode assembly with a thickness of 1700 microns.

### Embodiment 5

The fabrication method of the membrane electrode assembly of this embodiment includes the fabrication of the conductive substrate, the gas diffusion electrode, and finally, the membrane electrode assembly. The fabrication of the conductive substrate includes the following steps:

soaking carbon paper in a PTFE paste where the content of the PTFE in said paste is 2%;

drying with heat at a temperature 20° C.;

placing said dried paper in a furnace;

raising the temperature of said furnace to 260° C.;

maintaining that temperature for 25 minutes;

raising the temperature to 300° C.; and

maintaining that temperature for 23 minutes to obtain a conductive substrate.

The fabrication of the gas diffusion electrode includes the following steps:

mixing acetylene black a PTFE paste to form a paste, where the content of the PTFE in said paste is 5%;

spray coating the conductive substrate with said paste;

drying said coated conductive substrate with heat at 50° C.;

placing said dried conductive substrate in a furnace;

raising the temperature of the furnace to 250° C.;

maintaining that temperature for 26 minutes;

raising the temperature to 300° C.;

maintaining that temperature for 23 minutes;

cooling to room temperature to form a layer of first material having carbon;

first hot-pressing the cooled conductive substrate with a layer of carbon black (first material having carbon) at 60° C. and a pressure of 0.05 MPa for 100 seconds;

first cooling with water at a pressure of 0.05 MPa to avoid distortion and obtain a gas diffusion layer, where the thickness of the gas diffusion layer after first hot-pressing is 100 microns, 1% less than the thickness of the layer of first material having carbon before said first hot-pressing;

formulating the catalyst paste by mixing uniformly with ultrasound a catalyst, a solvent, a pore forming agent, and Nafion solution, where the catalyst is Pt/C where the content of said Pt is 20%; the solvent is a mixture of isopropyl alcohol and water; the pore forming agent is ammonium acetate; and the ratio of the catalyst:solvent:pore forming agent:Nafion solution is 1:15:5:1;

coating the catalyst paste on the diffusion layer where spray coating can be the coating method;

second hot-pressing at a temperature of 20° C. and a pressure of 0.05 MPa for 10 seconds; and

second cooling with water at a pressure of 0.05 MPa to avoid distortion and obtain a gas diffusion electrode, where the thickness of the gas diffusion electrode after said second hot-pressing is 150 microns, 1% less than the thickness of the conductive substrate with said gas diffusion layer and said layer of catalyst material before said second hot-pressing.

The method for fabricating the membrane electrode assembly includes the following steps:

placing and aligning a treated Nafion 112 membrane between two gas diffusion electrodes obtained from the first and second hot-pressing;

third hot-pressing at a temperature of 100° C. and a pressure of 3 MPa for 30 seconds;

removing from heat immediately; and

third cooling with water to room temperature at a pressure of 3 MPa to avoid separation and obtain a a three-in-one membrane electrode assembly with a thickness of 350 microns.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

1. A method for fabricating a gas diffusion electrode, comprising the steps of:
forming a layer of first material having carbon onto a conductive substrate;
first hot-pressing said conductive substrate with said layer of first material having carbon at a first hot-pressing pressure and at a first hot-pressing temperature;
first cooling at a first cooling pressure to form said gas diffusion layer on said conductive substrate;
coating a layer of catalyst material onto said gas diffusion layer;
second hot-pressing at a second hot-pressing pressure and at a second hot-pressing temperature; and
second cooling at a second cooling pressure to form said gas diffusion electrode.

2. The method for fabricating a gas diffusion electrode of claim 1 wherein a method for fabricating said conductive substrate comprising the steps of:
maintaining a second material having carbon at a first maintenance temperature; and
maintaining said second material having carbon at a second maintenance temperature to obtain said conductive substrate.

3. The method for fabricating a gas diffusion electrode of claim 1 wherein a method for fabricating said conductive substrate further comprising the steps of:
maintaining a second material having carbon at a temperature of between 240° C. and 290° C. for 15 minutes to 30 minutes; and
maintaining said second material having carbon at a temperature of between 300° C. and 360° C. for 15 minutes to 30 minutes to obtain said conductive substrate.

4. The method for fabricating a gas diffusion electrode of claim 1 wherein said forming step further comprising the sub-steps of:
coating a layer of third material having carbon onto said conductive substrate;
maintaining said third material having carbon at a third maintenance temperature; and
maintaining said third material having carbon at a fourth maintenance temperature to form said layer of first material having carbon onto said conductive substrate.

5. The method for fabricating a gas diffusion electrode of claim 1 wherein said forming step further comprising the sub-steps of:
coating a layer of third material having carbon onto said conductive substrate;
maintaining said third material having carbon at a temperature between 240° C. and 290° C. for 15 minutes to 30 minutes;
maintaining said third material having carbon at a temperature between 300° C. and 360° C. for 15 minutes to 30 minutes; and
cooling to form said layer of first material having carbon onto said conductive substrate.

6. The method for fabricating a gas diffusion electrode of claim 1 wherein said first hot-pressing temperature is between 20° C. and 120° C., said first hot-pressing pressure is between 0.05 Mpa and 5 Mpa, and said first cooling pressure is between 0.05 Mpa and 5 Mpa.

7. The method for fabricating a gas diffusion electrode of claim 1 wherein said second hot-pressing temperature is between 20° C. and 120° C., said second hot-pressing pressure is between 0.05 Mpa and 5 Mpa, and said second cooling pressure is between 0.05 Mpa and 5 Mpa.

8. The method for fabricating a gas diffusion electrode of claim 1 wherein in said first and second cooling steps, said cooling is done naturally or with water.

9. The method for fabricating a gas diffusion electrode of claim 1 wherein the thickness of said gas diffusion layer is 80% to 99% of the thickness of said layer of first material having carbon.

10. The method for fabricating a gas diffusion electrode of claim 1 wherein the thickness of said gas diffusion electrode is 80% to 99% of the thickness of said conductive substrate with said gas diffusion layer and said layer of catalyst material, before said second hot-pressing step.

11. The method for fabricating a gas diffusion electrode of claim 1 wherein said catalyst material is a mixture comprising of: Pt/C catalyst, solvent, pore forming agent and Nafion solution.

12. The method for fabricating a gas diffusion electrode of claim 11 wherein the ratio of: Pt/C catalyst:solvent:pore forming agent:Nafion solution is 1-30:10-100:3-30:1-10.

13. The method for fabricating a gas diffusion electrode of claim 11 wherein said solvent is a mixture of isopropyl alcohol and water, and, said pore forming agent is at least one ammonium compound selected from the group consisting of: ammonium bicarbonate, ammonium formate, ammonium acetate or ammonium oxalate.

14. The method for fabricating a gas diffusion electrode of claim 2 wherein the method for fabricating said second material having carbon comprising the step of:
soaking a fourth material having carbon in a first PTFE material wherein the content of the PTFE in said first PTFE material is between 2% and 35%.

15. The method for fabricating a gas diffusion electrode of claim 4 wherein said third material having carbon is a mixture of a second PTFE material and a carbon material selected from the group consisting of: VXC-72 carbon black, acetylene black.

16. A method for fabricating a membrane electrode assembly for a proton exchange fuel cells, comprising the steps of:
forming a layer of first material having carbon onto a conductive substrate;
first hot-pressing said conductive substrate with said layer of first material having carbon at a first hot-pressing pressure and at a first hot-pressing temperature;
first cooling at a first cooling pressure to form said gas diffusion layer onto said conductive substrate;
coating a layer of catalyst material onto said gas diffusion layer;
second hot-pressing at a second hot-pressing pressure and at a second hot-pressing temperature;
second cooling at a second cooling pressure to form said gas diffusion electrode;
placing a membrane between two gas diffusion electrodes wherein each gas diffusion electrode is a gas diffusion electrode that is obtained after said second cooling step;
third hot-pressing at a third hot-pressing pressure and a third hot-pressing temperature; and
third cooling at a third cooling pressure to obtain said membrane electrode assembly.

17. The method for fabricating a membrane electrode assembly of claim 16 wherein in said third cooling step, said cooling is performed naturally or with water.

18. The method for fabricating a membrane electrode assembly of claim 16 wherein the thickness of said membrane electrode assembly is 80% to 99% of the thickness of said membrane with two gas diffusion electrodes, before said third hot-pressing step.

19. The method for fabricating a membrane electrode assembly of claim 16 wherein said third hot-pressing temperature is between 100° C. and 140° C., said third hot-pressing pressure is between 3 Mpa and 10 Mpa, and said third cooling pressure is between 3 Mpa and 10 Mpa.

20. A method for fabricating a membrane electrode assembly, comprising the steps of:
soaking a fourth material having carbon in a first PTFE material wherein the concentration of the PTFE in said first PTFE materials 2% to 35%; and
drying said soaked fourth material having carbon to form a second material having carbon;
maintaining said second material having carbon at a temperature of between 240° C. and 290° C. for 15 minutes to 30 minutes;
maintaining said second material having carbon at a temperature of between 300° C. and 360° C. for 15 minutes to 30 minutes to form a conductive substrate;
coating a third material having carbon on said conductive substrate;
maintaining a third material having carbon at a temperature of between 240° C. and 290° C. for 15 minutes to 30 minutes;
maintaining said third material having carbon at a temperature of between 300° C. and 360° C. for 15 minutes to 30 minutes;
cooling to form a layer of first material having carbon on said conductive substrate;
first hot-pressing said conductive substrate with said layer of first material having carbon at a pressure between 0.05 Mpa and 5 Mpa and at a temperature between 20° C. and 120° C. for 30 seconds to 300 seconds;
first cooling at a pressure between 0.05 Mpa and 5 Mpa to form a gas diffusion layer onto said conductive substrate;
coating a layer of catalyst material onto said gas diffusion layer;
second hot-pressing said conductive substrate with said gas diffusion layer and said layer of catalyst material at a second pressure between 0.05 Mpa and 5 Mpa and at a temperature between 20° C. and 120° C. for 10 seconds to 300 seconds;
second cooling at a pressure between 0.05 Mpa and 5 Mpa to obtain said gas diffusion electrode;
placing a membrane between two gas diffusion electrodes wherein each gas diffusion electrode is a gas diffusion electrode that is obtained after said second cooling step;
third hot-pressing said membrane with two gas electrodes at a pressure between 3 Mpa and 10 Mpa and a temperature between 100° C. and 140° C. for 30 seconds to 300 seconds;
third cooling at a between 3 Mpa and 10 Mpa to obtain said membrane electrode assembly; and
wherein
in said first, second, and third cooling steps, said cooling is conducted by natural cooling or water cooling;
the thickness of said gas diffusion layer is 80% to 99% of the thickness of said layer of first material having carbon;
the thickness of said gas diffusion electrode is 80% to 99% of the thickness of said conductive substrate with said gas diffusion layer and said layer of catalyst material, before said second hot-pressing step;
said catalyst material is a mixture comprising of: Pt/C catalyst, solvent, pore forming agent and Nafion solution;
the ratio of: Pt/C catalyst:solvent:pore forming agent:Nafion solution is 1-30:10-100:3-30:1-10;
said solvent is a mixture of isopropyl alcohol and water and said pore forming agent is at least one ammonium compound selected from the group consisting of: ammonium bicarbonate, ammonium formate, ammonium acetate or ammonium oxalate; and
said third material having carbon is a mixture of a second PTFE material and a carbon material selected from the group consisting of: VXC-72 carbon black, acetylene black.
